(19) United States
(12) Patent Application Publication
(10) Pub. No.: US 2013/0125133 A1
(43) Pub. Date: May 16, 2013

(54) System and Method for Load Balancing of Fully Strict Thread-Level Parallel Programs

(71) Applicant: Michael D. Schuster, Woodside, CA (US)

(72) Inventor: Michael D. Schuster, Woodside, CA (US)

(21) Appl. No.: 12/475,212

(22) Filed: May 29, 2009

(51) Int. Cl. G06F 9/46

(52) U.S. Cl. 718/105

(57) ABSTRACT

A system and method for executing fully strict thread-level parallel programs and performing load balancing between concurrently executing threads may allow threads to efficiently distribute work among themselves. A parent function of a thread may spawn children on one or more processors, pushing a stack frame onto a deque, then may sync by determining whether its children remain in the deque. If not, and/or if not all stolen children have returned, the thread may abandon its stack as an orphan, acquire an empty stack, and begin stealing work from other threads. Stealing work may include identifying an element in a deque of another thread, removing the element from the deque, and executing the associated child function. If this is the last child of a parent on the other thread's orphan stack, the thread may release its stack, adopt the orphan stack of the other thread, and continue its execution.

### BACKGROUND

### DESCRIPTION OF THE RELATED ART

The increasing use of multi-core, multi-threaded processors is having a correspondingly impact on software programming paradigms. As more of these processors are introduced into the market, it becomes increasingly important for programmers to figure out how to divide up their work to take advantage of the performances gains that may result from executing portions of those programs in parallel on multiple cores. Parallel programming techniques may yield benefits for a wide variety of applications, including image processing applications and search engines. For example, in order to perform a search over a large search domain, a programmer may configure a search engine to distribute independent, concurrently executing searches to a large number of machines, each of which is directed to a subset of the search domain. The results of each of these searches may be combined and returned to the search requestor. Similarly, some editing operations performed on an image may be broken up into multiple editing operations, each performed (in parallel) on a portion of the image. The results of these editing operations may be combined to produce an output image for the overall operation.

Previous approaches to managing thread-level parallelism include the use of compiler directives to identify opportunities for concurrent execution and various algorithms for performing work sharing and/or work stealing. For example, a multi-threaded language Cilk, uses the keywords “spawn” and “sync” to express the desired thread-level parallelism of a program, i.e. to allow the programmer to control (or at least influence) parallelism. By judiciously sprinkling spawns and syncs within a program, the programmer identifies functions that may be executed in parallel with the calling function. Specifically, the spawn keyword indicates to the compiler that it should create a new item of work and put it in a shared queue to be worked on. The sync keyword indicates to the compiler that program (or thread) execution cannot continue beyond that point until all the spawned children have finished and returned. Unlike an ordinary function call where the calling function, or parent, continues to run only after the called function or child returns, in the case of a spawn the parent may continue to run in parallel with the child. In general, a parent may continue to spawn more children to obtain more thread-level parallelism. However, a parent cannot safely use the results computed by a child it has spawned until it runs the sync. If any of the children the parent has spawned have not returned when it syncs, the parent suspends and does not resume until all of its children have returned. When all of its children have returned, the parent continues to run at the point immediately following the sync. The spawn and sync keywords provide a mechanism for expressing parallelism dependencies between parent and child only. This restricted form of parallelism is called fully strict thread-level parallelism.

The spawn and sync compiler directives specify which parts of a program may potentially run in parallel. What actually runs in parallel is determined at runtime by a scheduler that maps a program's computation onto a multi-core computer. The spawn and sync keywords are not supported by commercially available compilers. The code generated by academic research and/or experimental compilers that do support these compiler directives is not supported by commercially available debuggers.

When executing a computer program, computer memory is allocated in different ways and at different times for various purposes. For example, memory dedicated to program instructions is typically not modified during execution. Memory dedicated to program data (e.g., image data) may typically be modified during execution of an application. This memory may be considered a temporary workspace for the application. It may be dynamically allocated on an as-needed basis throughout the execution of the application, and may be dynamically de-allocated (i.e. released) when the program no longer needs it. A fixed amount of stack memory, used for internal operations of the processor on which a program executes, is typically pre-allocated for the program (e.g., by the operating system) upon invocation of the program.

Previous approaches to thread-level parallelism that employ the compiler directives described above (i.e. the spawn and sync keywords) use stack frame continuations to manage memory at runtime. With this approach, at each spawn, the parent's local variables are copied into a dynamically allocated stack frame for later restoration by the thread that executes code immediate following the spawn. With this approach, load balancing efforts focused on keeping processors busy through work sharing and/or work stealing, in which a thread other than the parent took over one of these dynamically allocated stack frames and continued execution.

### SUMMARY

A system and method for executing fully strict thread-level parallel programs and performing load balancing between concurrently executing threads may allow multiple cores, or threads thereof, to efficiently distribute work among themselves. The system and methods described herein may provide efficient and practical scheduling and load balancing for fully strict thread-level parallel programs that is supported by commercially available compilers and debuggers, and that does not require the overhead associated with dynamic allocation of stack frame memory of previous approaches. The system and methods described herein may be well suited for use in production software applications such as simulation, rendering, image processing, and game tree searches, where any loss of parallel scalability compared to previous approaches may be negligible. The system and methods described herein may employ a simple programming interface, which may be based on the C or C++ programming language, in some embodiments.

In some embodiments of the system supporting multi-threaded execution, a parent function of an executing thread may spawn one or more child functions suitable for execution in parallel with the parent function on one or more processors. Spawning a child function may include pushing a respective stack frame element associated with the child function onto a double-ended queue (deque) that is associated with the executing thread and that is configured to record spawns of the executing thread. After spawning one or more children, the parent function may execute a sync function associated with the one or more children. Executing the sync function may include determining whether any of the stack frame elements associated with the spawned children remain in the spawn/sync deque. In some embodiments, this determination may be dependent on a value of one or more performance counters, such as a counter whose value reflects the number of the children that have been executed by a thread other than that executing the parent function.

In some embodiments, in response to determining that none of the spawned children remain in the spawn/sync deque and/or that not all stolen children have returned, the executing thread may abandon its current call/return stack as an orphan stack and begin using an acquired, empty stack as its new call/return stack. The executing thread may then begin attempting to steal work from other threads executing in the system.

In some embodiments, stealing work from another thread may include identifying a stack frame element in a deque associated with the other thread that is associated with a spawned child function available for execution. If such a stack frame is identified, the executing thread may remove the identified stack frame element from the deque associated with the other thread, and execute the associated spawned child function (i.e. the child function it has just stolen). In some embodiments, the executing thread may determine whether the stolen child function is the last child function of a spawning function on an orphan stack of the other thread to be executed. If so, the executing thread may release its new call/return stack, adopt the orphan stack of the other thread as an adopted call/return stack, and continue execution of the other thread at a point beyond a sync associated with the last child function.

In some embodiments, if at least one of the spawned children remains in the double-ended queue, the executing thread may remove one or more of the stack frame elements associated with the spawned children and may execute the respective children associated with the removed stack frame elements. Once no more spawned children remain in the deque, the thread may continue execution beyond the corresponding sync, or, if any stolen children have not yet returned, may abandon its call/return stack as an orphan stack, acquire a new call/return stack, and attempt to steal work from other threads, as described above.

In some embodiments, for each of a plurality of threads executing in the system (or participating in a multi-threaded computation), the system may pre-allocate storage space in memory for a spawn/sync deque and two or more stacks. The two or more stacks may include a current call/return stack for the thread and one or more other stacks that may be subsequently acquired and/or adopted as orphan stacks, as described herein.

In some embodiments, the system may implement the methods described herein using one or more library functions. For example, in some embodiments, spawning a child function may include invoking execution of a library function executable to implement pushing a stack frame element associated with the spawned child onto the double-ended queue. Similarly, executing a sync may include invoking execution of a library function executable to perform the operations described above involving a sync associated with one or more spawns. Other library functions may also be included in the system to support executing fully strict thread-level parallel programs and performing load balancing between concurrently executing threads.

In various embodiments, the methods described herein may be implemented as program instructions, (e.g., stored on computer-readable storage media) executable by one or more CPUs and/or GPUs, including one or more multi-core or multi-threaded processors. For example, they may be implemented as program instructions that, when executed, implement a fully strict thread-level parallel program and/or a library of functions to support execution of that program and/or load balancing between concurrently executing threads.

### BRIEF DESCRIPTION OF THE DRAWINGS

FIG. 1 is a flow diagram illustrating a method for executing a multi-threaded program exhibiting fully strict thread-level parallelism, according to various embodiments.

FIG. 2 illustrates various data structures associated with a thread in a system supporting thread-level parallelism, according to one embodiment.

FIG. 3 is a flow diagram illustrating a method for performing thread-level parallelism, according to various embodiments.

FIG. 4 is a flow diagram illustrating a method for performing work stealing, according to various embodiments.

FIG. 5 illustrates a computer system configured to implement fully strict thread-level parallelism, according to one embodiment.

While several embodiments and illustrative drawings are included herein, those skilled in the art will recognize that embodiments are not limited to the embodiments or drawings described. It should be understood, that the drawings and detailed description thereto are not intended to limit embodiments to the particular forms disclosed, but on the contrary, the intention is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description that follows are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

The system and methods described herein may provide efficient and practical scheduling and load balancing for fully strict thread-level parallel programs. The system may employ a simple programming interface, such as one based on the C or C++ programming language, that is supported by commercially available compilers and debuggers, and that does not require dynamic allocation of memory at runtime for any purpose. Instead, all required memory may be pre-allocated, including stacks and deques. The system and methods described herein may provide load balancing for fully strict thread-level parallelism that may achieve good performance, that may maintain enough concurrently active threads to keep multiple available processors (or cores thereof) busy, that may maintain a number of concurrently active threads that meets reasonable memory requirements, and that may execute related threads on the same processor, in many cases. While the system and methods described herein may in some embodiments impose a stack space limit that may limit performance in the worst case, in practice, the impact may be negligible for a wide range of software applications. Because the system and methods rely on library functions rather than compiler directives or language extensions, they may be easily ported to different compilers and/or computer architectures.

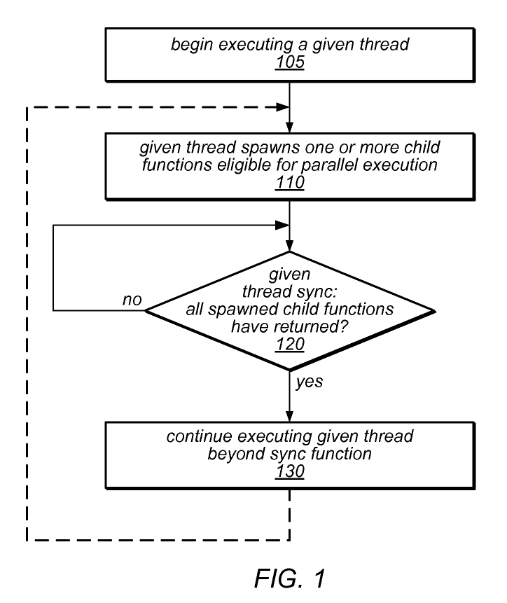

FIG. 1 is a flow diagram illustrating a method for executing a multi-threaded program exhibiting fully strict thread-level parallelism, according to various embodiments. In this example, the method may include beginning execution of a given thread, as in 105. As illustrated in FIG. 1, the given thread may spawn one or more child functions eligible for parallel execution, as in 110. For example, the thread may call one or more functions that may be independently and concurrently executed in parallel with each other or in parallel with their parent (i.e. the calling thread or another calling function when nesting is present), if multiple cores on which to execute them are available. In some embodiments, functions that can be spawned may be implemented by a functor struct and an associated function, as described in more detail below.

As illustrated in FIG. 1, when the given thread executes a sync function call, the method may include determining if all spawned children have returned, as in 120. For example, in various embodiments, the method may include examining a call/return stack, a spawn/sync deque (described in more detail below) and/or one or more performance counters to determine if all spawned children have returned. If not, shown as the negative exit from 120, the method may include suspending execution of the current program flow until all of the children have returned. Once all of the spawned children have returned, shown as the positive exit from 120, the method may include continuing execution of the given thread at the point immediately following the sync function, as in 130. For example, in some embodiments, the method may include continuing execution of the program according to information in a stack frame popped from a call/return stack in response to returning from a sync function call. As illustrated by the dashed line from 130 to 110 in FIG. 1, in some embodiments, continuing execution may include spawning one or more other child functions associated with a respective sync function and repeating the operations illustrated in 110, 120, and 130 for those functions.

In one example of the application of the method illustrated in FIG. 1, in an image editing application, a user may wish to blur an input image. A blur operation may be well suited for distribution across multiple cores. In this example, if the processor on which the operations are executing comprises 8 cores, the input image may be broken up into 8 regions. In this example, 8 blur operations may be spawned to perform the overall blur operation (e.g., by calling 8 spawnable child function calls), each targeting one of the 8 regions of the image. This may place 8 work items (blur operations) in a queue to be executed by the spawning thread or by any other thread(s) that may be available to perform one or more of these operations. In this example, the overall blur operation may be executed by up to 8 independently and concurrently executing threads, depending on the number of cores available to steal work items from the queue. In this example, a sync function call placed after the 8 child function calls may ensure that all 8 spawned blur operations are performed before execution continues (e.g., before any other editing operations are performed on the output image constructed from the results of the 8 blur operations).

In this example, another image editing operation well suited for parallel execution (e.g., a change contrast operation) may be applied to the output of the blur operation in a similar manner. For example, following the sync function call described above, 8 child function calls may be spawned to perform respective change contrast operations on up to 8 different cores, each targeted to one of 8 regions of the output image. A sync function call following these 8 spawned change contrast operations may ensure that all 8 change contrast operations are completed before a final output image is generated from the results and/or further edited.

Note that in some embodiments and/or for some cases, there may be more spawned functions than available cores. Therefore, each of the available cores may execute more than one spawned function. For example, if a blur operation is to be performed on a large image by a processor comprising 8 cores, the image may be broken up into 16, 32, or any other number of regions for independent and concurrent processing, and a corresponding number of functions may be spawned (e.g., 16, 32, etc.). However, only 8 or fewer of these spawned operations may be executed at one time, one on each of the 8 available cores.

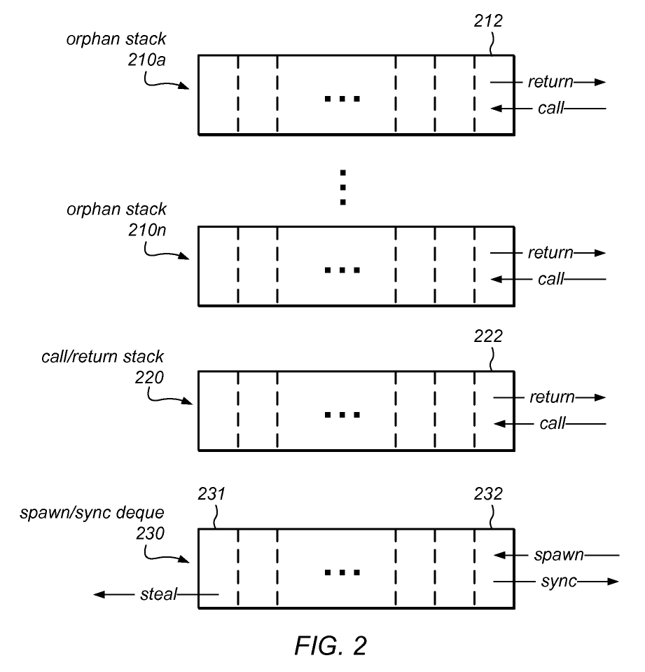

The system described herein may implement load balancing as a variant of previous work stealing approaches involving “greedy-scheduling” (in which, at each step, if at least P instructions are ready, then P instructions execute, and if fewer than P instructions are ready, then all execute, where P is the number of processors), and the “busy-leaves” property (which states that for each abandoned stack there exists at least one thread that is currently executing a child or a descendent child of the delayed parent that forced the creation of that abandoned stack). In some embodiments, associated with each scheduled software thread are two or more stacks (e.g., call/return stacks) and a double-ended queue, or deque, to track spawns and corresponding syncs. These data structures are illustrated in FIG. 2, according to one embodiment. As illustrated in this example, each software thread may be associated with a currently active call/return stack 220 and a spawn/sync deque 230. The call/return stack 220 may in some embodiments be implemented as an ordinary C/C++ function call stack, (e.g., created and managed by the compiler and/or operating system) in which stack frames are pushed and/or popped from one end of the stack (in this case, the right side of the stack). For example, when a function call is made, a stack frame may be pushed onto call/return stack 220 at position 222. Upon the return from that function call, the stack frame may be popped from the stack, as illustrated.

As illustrated in FIG. 2, the spawn/sync deque 230 may in some embodiments be implemented as a double-ended queue organized into stack frames. A stack frame of the deque associated with a particular parent function may contain multiple elements, each representing one of that parent's spawned children that has not yet begun execution. In this example, entries representing spawned children may be added to the right side of the deque, may be popped from the right side of the deque from the thread with which the deque is associated, or may be stolen from the left side of the deque by another thread. In this example, entry 232 may represent the most recently spawned child function and entry 231 may represent the oldest spawned child function in spawn/sync deque 230.

As illustrated in FIG. 2, in some embodiments, two or more additional stacks may be allocated to each thread, to be used as needed (e.g., as orphan stacks). These additional stacks are shown as orphan stacks 210a-210n in FIG. 2. These additional stacks as used in stack switches by sync functions, as described in more detail below. In some embodiments, their structure and operation may be similar to those of call/return stack 220. For example, as illustrated in FIG. 2, entries may be pushed or popped from one end of an orphan stack 210 in response to a function call or return.

In some embodiments, nesting of spawn/sync functions may be implemented in a manner similar to the manner in which standard function calls and returns are nested. For example, when a standard function call is made, a new stack frame is pushed onto a call/return stack (including its arguments and information reflecting the current program state). If that function calls a second function, a stack frame for the second function is pushed onto the call/return stack, and so on. When the lowest level child function returns, its stack frame is popped off the stack, followed by the stack frame of its parent function, and so on in reverse order. Similarly, new spawns may be pushed onto the right side of a thread's spawn/sync deque until a sync is encountered. A spawned function, when executed, may spawn other functions, which may be pushed onto the deque as well. For each level of nesting, all of the children of a parent thread must be returned before execution can continue beyond a corresponding sync function call of the parent.

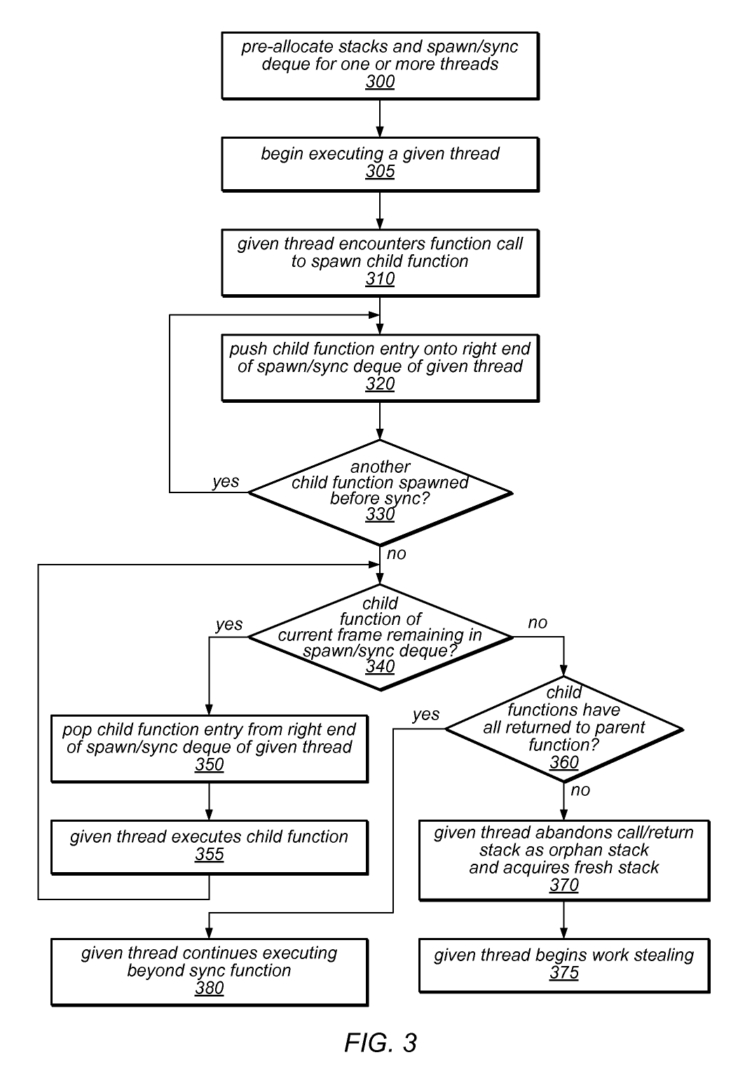

One method for performing thread-level parallelism is illustrated by the flow diagram in FIG. 3, according to various embodiments. As illustrated in FIG. 3, in some embodiments, the method may include pre-allocating various stacks for each of one or more threads, as in 300 (e.g., an initial call/return stack for the thread and additional stacks to be subsequently used as orphan stacks and/or swapped with a thread's current call/return stack). The method may also include pre-allocating a spawn/sync deque for each of one or more threads. The method may include beginning execution of a given thread, as in 305. The method may include the given thread encountering a function call to spawn a child function, as in 310.

As illustrated at 320 of FIG. 3, when a parent function spawns a child, the method may include the parent pushing an element representing the child function into its frame on the right end of the spawn/sync deque. One such spawn/sync deque element is described in more detail below. As illustrated by the feedback from 330 to 320, the parent function may spawn multiple children, repeating the operations illustrated as 320 and 300, and filling up its frame in the spawn/sync deque, until a call to a sync function is encountered. When a parent function syncs, the method may include determining if any of its spawned children (i.e. those pushed into the associated stack frame in the spawn/sync deque) remain in the deque, as in 340. If so, shown as the positive exit from 340, the method may include the parent function repeatedly popping elements from its associated stack frame on the right end of the deque and executing their associated children. This is illustrated in FIG. 3 as 350, 355, and the feedback loop from 355 to 340.

If it is determined that none of the spawned children remain in the spawn/synch deque (i.e. that they have all been stolen), shown as the negative exit from 340, the method may include determining if all of the spawned children have returned to the parent function, as in 360. This determination may in some embodiments be dependent on information contained in the deque elements for each spawned child. In some embodiments, various performance counters (e.g., counters that track the number of steals completed, adoptions completed, steals stalled, or adoptions stalled) may be employed and/or examined in determining whether all of the spawned children have returned and/or been executed, as described in more detail below. If so, shown as the positive exit from 360, the method may include the given thread continuing execution beyond the sync function, as in 380. For example, the method may include popping a stack frame associated with the sync function call from the thread's call/return stack and continuing execution according to the retrieved program state information.

If, on the other hand, not all of the spawned children have returned to the parent function, shown as the negative exit from 360, the thread cannot continue executing out of its own (call/return) stack beyond the sync. However, rather than allowing the thread executing the parent to merely fall idle, the method may include the thread executing the parent itself becoming a thief. In some embodiments, this approach may allow available processors to keep busy, which may improve performance over approaches in which such a thread would stall waiting for its children to return. In some cases, the thread executing the parent may steal children spawned by its own children. As illustrated in FIG. 3, the method may include the thread abandoning its current call/return stack as an orphan stack before it begins stealing, and the thread beginning to steal work using an acquired, empty call/return stack (e.g., one that has not yet been used or that is no longer in use by the thread). This is shown as 370 and 375 in FIG. 3. In this example, the abandoned stack may remain an orphan until the last stolen child returns.

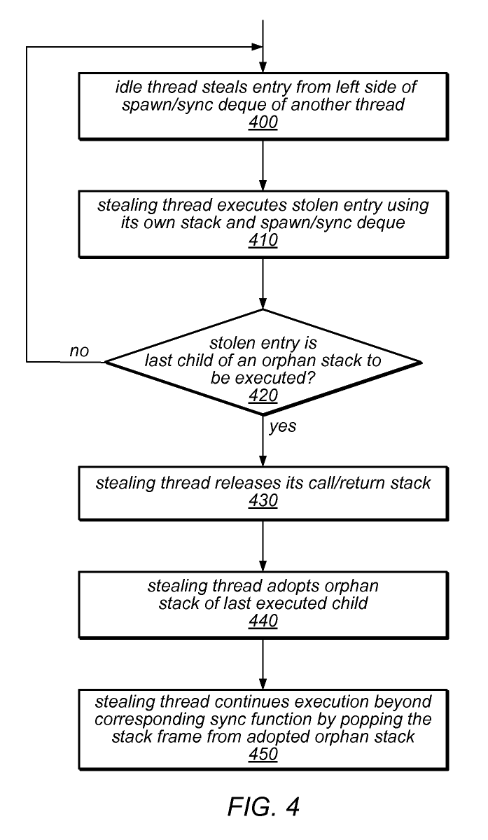

In various embodiments, as soon as a spawned child is recorded in a thread's spawn/sync deque, it may be stolen from the left side of the deque by an idle thread, allowing the program to take advantage of parallel processing on multiple cores to potentially improve performance. FIG. 4 is a flow diagram illustrating a method for performing such work stealing, according to one embodiment. In this example, the method includes an idle thread, i.e. one that has no work to do, becoming a thief and attempting to steal an element from the left end of the deque of a victim thread, as in 400. In some embodiments, the victim thread may be chosen randomly, while in others, the method may include applying various heuristics in choosing a victim thread (e.g., to attempt to keep related work items on the same processor, or to distribute work items according to the amount or type of work, the memory requirements, etc.) In various embodiments, and at various times, a thread may be idle for different reasons. For example, a program execution may have just begun and no work has been scheduled for the thread to do yet, the thread may have recently abandoned its stack as an orphan stack (as in 370 of FIG. 3), or the thread may have recently run out of work to do.

As illustrated in FIG. 4, the method may include the stealing thread executing the child function associated with the stolen element using its own stack and deque, as in 410. As noted above, before a thread begins stealing, it may abandon its current stack and acquire an empty (fresh) stack, and the abandoned stack may remain an orphan until its last stolen child returns. In the example illustrated in FIG. 4, the work stealing method may include determining if the stolen entry is the last child associated with an orphan stack to be executed and returned, as in 420. If not, shown as the negative exit from 420, the method may include the stealing thread attempting to steal another entry from the left side of a spawn/sync deque of another thread (i.e. the same thread from which it has previously stolen an entry, or a different thread). This is illustrated as the feedback from 420 to 400. In this example, the operations illustrated in 400-420 may be repeated as long as there is work for the stealing thread to steal or until the stealing thread steals and executes the last child of an orphan stack to be executed and returned.

If the stolen entry is the last child of an orphan stack to be executed and returned, shown as the positive exit from 420, the method may include the stealing thread, rather than becoming a thief again, releasing its current call/return stack, as in 430, and adopting the orphan stack, as in 440. The method may include the stealing thread continuing execution beyond the sync function associated with the last stolen child by popping the corresponding stack frame from the adopted orphan stack and restarting its execution, as in 450. In other words, the thread that executed the last stolen child associated with an orphan stack may perform a stack switch (though not a deque switch) to adopt the orphan stack and continue execution of the orphaned thread at the point beyond the associated sync in program order. Thus, the thread may effectively take over the flow of execution of the last stolen child's original parent thread.

The use of orphan stacks described herein may allow the system to satisfy the busy-leaves property described above, since every orphan stack has at least one associated executing child. The use of orphan stacks may in some embodiments entail internal memory fragmentation, since in general only parts of the fixed sized, mapped stacks are physically referenced. In such embodiments, the unreferenced parts consume virtual address space and reserved page file space but not physical page space in shared-memory. To limit the amount of internal fragmentation and to avoid the need for dynamically allocated stack memory, the system may in some embodiments pre-allocate a fixed number of stacks for each scheduled software thread. In some embodiments the fixed bound on stack space may compromise the parallel scalability of scheduling and/or load balancing in the worst case. For example, in some embodiments a thread may block on a sync rather than abandon its current stack if it has exhausted its own set of available stacks. In typical production software applications, however, the number of orphan stacks may remain small and the loss of scalability may be negligible.

For example, in some embodiments, the system may pre-allocate 8 or 16 stacks per thread, in addition to one spawn/sync deque per thread. However, the programmer may not use them all. Note that in some embodiments the number of threads that may execute concurrently may be equal to the number of processors or the number of cores in a multi-core processor. In other embodiments, the number of effective threads may be greater than the number of cores, e.g., in systems supporting hyper-threading. For example, for a processor that includes 8 cores, each of which supports up to 8 threads, there may be 64 independent, (effectively parallel) concurrently executing threads, each with 8 or 16 stacks and 1 deque. While it may be theoretically possible for a thread to run out of stacks, such that none is available for an orphan, in practice, selecting the number and size of stacks based on static code analysis may make this rare for a wide variety of applications. In some embodiments, in the case that this does occur, a thread may stall until all of the parent function's children have completed.

In some embodiments, when a parallel computation begins, all scheduled software threads but one are idle and immediately become thieves. The remaining thread (the non-idle thread) may begin execution of the root function. As soon as the root function spawns children, thieves may begin to complete their steal attempts and start productive work. When the root function returns, all threads are idle and the computation terminates.

As previously noted, the system and methods described herein may implement the spawn and sync keywords in terms of function calls to a runtime library. In some embodiments, the system may implement a load balancer that distributes work among threads based on these and other library functions configured to support the methods described herein. The load balancer described herein may employ non-blocking communication protocols, with a single exception, so that an arbitrary and unexpected delay by one thread does not necessarily prevent other threads from making progress. The single exception may occur when a victim's spawn/sync deque contains exactly one element. In this case, a thief that delays while stealing the last remaining element of a victim's spawn/sync deque may block the victim from completing a sync for the duration of the thief's delay.

As previously noted, in some embodiments, all allocated memory used by the load balancer, including stack and deque memory, is pre-allocated when the load balancer is created and initialized. The load balancer does not dynamically allocate memory during a computation and so it cannot fail due to an out of memory error during a computation. Note however that an attempt to allocate dynamic memory by client code run by a spawned function may fail due to an out of memory error, in some embodiments.

As previously noted, in some embodiments, the system described herein may employ a C or C++ language library for programming multiple processing cores. It may include a programming interface that provides a simple facility for expressing fully strict thread-level parallelism, as described herein. Its runtime library may provide a load balancer that efficiently maps a thread-level parallel program's computation onto multiple processing cores. Since the system and methods described herein do no rely on compiler directives or extensions, they may be implemented in systems employing any of a variety of commercially available compilers and/or debuggers. The system described herein may provide facilities that are similar to those provided by the Cilk multithreaded language, but they are provided in a library form rather than as a language extension or compiler directive.

The system and methods described herein for load balancing program execution using thread-level parallelism may be further illustrated by way of example. In the following example, the methods are described with respect to a recursive sorting algorithm, merge sort. Merge sort partitions the input into two halves, sorts the halves recursively and then merges the sorted halves into a single sorted sequence. Merge sort may in some embodiments be parallelized by running the two recursive sorts in parallel, waiting for them to return, and then running the merge. A function for implementing this parallel algorithm is shown in the example pseudo code below. In this example, the function uses the spawn and sync keywords described above to express the desired thread-level parallelism. In this example, the input is defined by the range [first, last). Small inputs are sorted on line 3 by some other algorithm, such as an insertion sort. Large inputs are partitioned into halves defined by the ranges [first, middle) and [middle, last). The two halves are sorted recursively and in parallel on lines 6 and 7. The sorted halves are merged on line 9.

Pseudo code example 1: Thread-level parallel merge sort

| | |
|---|---|
| 1 | void merge_sort(sort_t* first, sort_t* last) { |
| 2 | if (last − first <= SMALL) |
| 3 | small_sort(first, last); |
| 4 | else { |
| 5 | sort_t* middle = first + ((last − first) / 2); |
| 6 | spawn merge_sort(first, middle); |
| 7 | spawn merge_sort(middle, last); |
| 8 | sync; |
| 9 | merge(first, middle, middle, last); |
| 10 | } |
| 11 } | |

In this example, the spawn keyword on line 6 in pseudo code example 1 indicates that the function call can run in parallel with the calling function. Unlike an ordinary function call where the calling function or parent continues to run only after the called function or child returns, in the case of a spawn, the parent may continue to run in parallel with the child. In this case, the parent may continue by spawning the second function call on line 7. In general, a parent may continue to spawn more children to obtain more thread-level parallelism, in various embodiments.

As previously noted, a parent cannot safely use the results computed by a child it has spawned until it runs a sync function. If any of the children it has spawned have not returned when it syncs, the parent may suspend the flow of execution and may not resume until all of its children have returned. When all of its children have returned, the parent may continue to run at the point immediately following the sync. In pseudo code example 1, a sync is required on line 8 to avoid the error that would occur if the two halves of the input were merged before they were sorted. A function for implementing the merge operation, which may also include multiple spawned child functions and a corresponding sync, is illustrated in pseudo code example 2 below.

Pseudo code example 2: Thead-level parallel merge

| | |
|---|---|
| 1 | void merge(sort_t* a, sort_t* b, sort_t* c, sort_t* d) { |
| 2 | if (b − a < d − c) { |
| 3 | swap(a, c); |
| 4 | swap(b, d); |
| 5 | } |
| 6 | if (b − a <= SMALL) |
| 7 | small_merge(a, b, c, d); |
| 8 | else { |
| 9 | sort_t* ab = a + ((b − a) / 2); |
| 10 | sort_t* cd = binary_search(c, d, *ab); |
| 11 | spawn merge(a, ab, c, cd); |
| 12 | spawn merge(ab, b, cd, d); |
| 13 | sync; |
| 14 | } |
| 15 | } |

The spawn and sync keywords in the examples above may in some embodiments indicate which parts of a program may potentially be run in parallel. However, in some embodiments, what actually runs in parallel may be determined at runtime by a load balancer (such as that described herein) that maps a computation of a program onto a multi-core processor. The spawn and sync keywords may provide a mechanism for expressing parallelism dependencies between parent and child only. This restricted form of parallelism is sometimes called fully strict thread-level parallelism. More general forms of parallelism with arbitrary dependencies may or may not be able to be scheduled efficiently using the system and methods described herein, in various embodiments.

The system and methods described herein may provide mechanisms for communicating data between threads to coordinate load balancing between threads in the system, including information to support the creation and adoption of orphan stacks and the tracking of stolen and completed children. In some embodiments, when a spawned child function is recorded on a thread's spawn/sync deque, the stack frame element representing that child in the deque may not include the entire program state, but may include the following: the name of the spawned function, the arguments passed to it, and additional pieces of state with information that support the load balancing techniques described herein. This addition state information may include the values of one or more performance counters used to keep track of the number of spawns that were stolen and that have, or have not, been completed and returned. These counters, and the interfaces provided for accessing them, are described in more detail below.

### C++ Programming Interface

The system and methods described herein may employ a C or C++ programming interface, in different embodiments. In some embodiments employing a C++ programming interface, the interface may require that a functor class be used to implement any functions that can potentially be spawned. Note that as used herein, the term “functor”, or “function object”, may refer to a function that has state. Pseudo code example 3 illustrates a declaration of a functor class merge_sort_t that implements thread-level parallel merge sort, as described above. In this and other examples, various functions include a prefix of “tlp”, representing the acronym for “thread-level parallelism”. In pseudo code example 3, the class derives from a base class tlp_function_t on line 3, supplies a constructor that takes arguments that define the input range on line 5, and supplies the function tlp_run( ) on line 8 that implements the algorithm. In this example, the constructor saves the values of its arguments in data members declared on lines 10 and 11.

Pseudo code example 3: Functor class merge_sort_t

| | |
|---|---|
| 1 | #include <tlp/tlp.h> |
| 2 | using namespace tlp; |
| 3 | class merge_sort_t: public tlp_function_t { |
| 4 | public: |
| 5 | merge_sort_t(sort_t* first, sort_t* last) : |
| 6 | first(first), last(last) { |
| 7 | } |
| 8 | int tlp_run( ); |
| 9 | private: |
| 10 | sort_t* first; |
| 11 | sort_t* last; |
| 12 | }; |

Continuing this example, a member function merge_sort_t::tlp run( ) is illustrated in pseudo code example 4. This function takes no arguments and instead uses the data members initialized by the constructor as its arguments. In this example, the spawn keywords may be implemented by calls to the inherited function tlp_spawn( ) on lines 7 and 9, each taking as an argument a reference to a distinct instance of the functor class merge_sort_t declared and appropriately constructed on lines 6 and 8. In this example, the sync keyword may be implemented by a call to the inherited function tlp_sync( ) on line 10. In some embodiments, the lifetime of each spawned functor class instance must persist until after the subsequent call to tlp_sync( ). In this example, the function merge_sort_t::tlp_run( ), as well as the functions prefixed by “tlp”, may return 0 if successful and may return a nonzero error number otherwise. Code to aggregate these returned error numbers is not shown. Descriptions of various returned error numbers are included in the programming interface reference description below, according to one embodiment.

Pseudo code example 4: Member function merge_sort_t::tlp_run( )

| | |
|---|---|
| 1 | int merge_sort_t::tlp_run( ) { |
| 2 | if (last − first <= SMALL) |
| 3 | small_sort(first, last); |
| 4 | else { |
| 5 | sort_t* middle = first + ((last − first) / 2); |
| 6 | merge_sort_t a(first, middle); |
| 7 | tlp_spawn(a); |
| 8 | merge_sort_t b(middle, last); |
| 9 | tlp_spawn(b); |
| 10 | tlp_sync( ); |
| 11 | merge(first, middle, middle, last); |
| 12 | } |
| 13 | return 0; |
| 14 | } |

In some embodiments, a call to the function tlp_spawn( ) followed immediately by a call to tlp_sync( ), as on lines 9 and 10 in pseudo code example 4, may be replaced by a single call to the function tlp_spawn_sync( ). In such embodiments, the function tlp_spawn_sync( ) may take the same argument as the function tlp_spawn( ) it replaces.

The program fragment illustrated in pseudo code example 5 illustrates a method for creating an instance of a load balancer and running a computation, according to one embodiment. In this example, an instance of class tlp_balancer_t is declared on line 1, created on line 2 and destroyed on line 6. In this example, the creation member function tlp_scheduler_create( ) takes four arguments. The argument “threads” specifies the number of software threads that will participate in the computation, “stack_size” specifies each thread's stack size in bytes, “deque_size” specifies each thread's deque size in bytes and “stack_limit” specifies an upper bound on the number of bytes of stack space mapped by each thread. In some embodiments, a default value may be used if an argument equals 0. Descriptions of these arguments and their default values are included in the programming interface reference description below, according to one embodiment. In this example, the calls to the member functions tlp_spawn_root( ) and tlp_sync_root( ) on lines 4 and 5 respectively spawn and sync the computation.

Pseudo code example 5: Load balancer creation and computation in C++

1 tlp_balancer_t s;
2 s.tlp_balancer_create(threads, stack_size, deque_size, stack_limit);
3 merge_sort_t a(first, last);
4 s.tlp_spawn_root(a);
5 s.tlp_sync_root( );
6 s.tlp_balancer_destroy( );

As in the previous example, in some embodiments a call to the function tlp_spawn_root( ) followed immediately by a call to tlp_sync_root( ), as on lines 4 and 5 in pseudo code example 5, may be replaced by a single call to the function tlp_spawn_sync root( ). In such embodiments, the function tlp_spawn_sync_root( ) may take the same argument as the function tlp_spawn_root( ) it replaces.

In some embodiments, the tlp_balancer_t creation and destruction functions tlp_balancer_create( ) and tlp_balancer_destroy( ) may have a relatively large time overhead. In such embodiments, to amortize this overhead across a series of computations, an instance of tlp_balancer_t may be reused multiple times by repeatedly calling the function tlp_spawn_sync_root( ) or the functions tlp_spawn_root( ) and tlp_sync_root( ) in strict alternation.

In some embodiments employing a C programming interface, the interface may require that a functor struct and an associated function be used to implement any functions that can potentially be spawned. In such embodiments, the functor struct may contain the function's argument values as well as load balancer state information. Pseudo code example 6 illustrates the declaration of a functor struct merge_sort_t that when associated with the function merge_sort_run( ) implements thread-level parallel merge sort, according to one embodiment. In this example, the first data member of merge_sort_t on line 3 is an instance of tlp_argument_t that contains load balancer state information. The remaining data members on lines 4 and 5 contain the function's argument values. In this example, the function merge_sort_create( ) declared on line 7 provides a convenient way to initialize these values.

Pseudo code example 6: Functor struct merge_sort_t

| | |
|---|---|
| 1 | #include <tlp/tlp.h> |
| 2 | typedef struct { |
| 3 | tlp_argument_t arg; |
| 4 | sort_t* first; |
| 5 | sort_t* last; |
| 6 | } merge_sort_t; |
| 7 | void merge_sort_create(merge_sort_t* m, sort_t* first, |
| | sort_t* last) { |
| 8 | m->first = first; |
| 9 | m->last = last; |
| 10 | } |

Continuing this example, a function merge_sort_run( ) is illustrated in pseudo code example 7. In this example, the function takes as an argument a pointer to the tlp_argument_t data member of an instance of merge_sort_t. In this example, a pointer to the merge_sort_t instance is obtained by the cast on line 2. This cast is valid since the tlp_argument_t data member is the first data member of merge_sort_t. In this example, values defining the input range are obtained on lines 3 and 4. In this example, spawns are implemented by declaring instances of the functor struct merge_sort_t (as shown on lines 9 and 10), calling the function merge_sort_create( ) to appropriately initialize these instances (as shown on lines 11 and 13), and calling the function tlp_spawn( ) (as shown on lines 12 and 14). In this example, the function tlp_spawn( ) takes as arguments a pointer to the tlp_argument_t passed as an argument to merge_sort_run( ), a pointer to the function to spawn, and a pointer to the tlp_argument_t data member of the associated functor struct instance. In some embodiments, the sync keyword may be implemented by a call to the function tlp_sync( ) with the tlp_argument_t pointer passed as an argument to merge_sort_run( ). In some embodiments, the lifetime of each spawned functor struct instance must persist until after the subsequent call to tlp_sync( ). In this example, the function merge_sort_run( ), as well as the functions prefixed by “tlp”, may return 0 if successful and may return a nonzero error number otherwise. Code to aggregate these returned error numbers is not shown. Descriptions of various returned error numbers are included in the programming interface reference description below, according to one embodiment.

Pseudo code example 7: Function merge_sort_run( )

| | |
|---|---|
| 1 | int merge_sort_run(tlp_argument_t* arg) { |
| 2 | merge_sort_t* m = (merge_sort_t*) arg; |
| 3 | sort_t* first = m->first; |
| 4 | sort_t* last = m->last; |
| 5 | if (last − first <= SMALL) |
| 6 | small_sort(first, last); |
| 7 | else { |
| 8 | sort_t* middle = first + ((last − first) / 2); |
| 9 | merge_sort_t a; |
| 10 | C merge_sort_t b; |
| 11 | merge_sort_create(&a, first, middle); |
| 12 | tlp_spawn(arg, merge_sort_run, &a.arg); |
| 13 | merge_sort_create(&b, middle, last); |
| 14 | tlp_spawn(arg, merge_sort_run, &b.arg); |
| 15 | tlp_sync(arg); |
| 16 | merge(first, middle, middle, last); |
| 17 | } |
| 18 | return 0; |
| 19 | } |

In some embodiments, a call to the function tlp_spawn( ) followed immediately by a call to tlp_sync( ), as on lines 14 and 15 in pseudo code example 7, may be replaced by a single call to the function tlp_spawn_sync( ). In such embodiments, the function tlp_spawn_sync( ) may take the same arguments as the function tlp_spawn( ) it replaces.

The program fragment in pseudo code example 8 illustrates one method for creating an instance of a load balancer and running a computation, according to one embodiment. In this example, an instance of the struct tlp_balancer_base_t is declared on line 1, created on line 2, and destroyed on line 7. In this example, the creation function tlp_balancer_create( ) takes five arguments. The first is a pointer to a tlp_balancer_base_t instance. As in the previous example, the argument “threads” specifies the number of software threads that participate in the computation, “stack_size” specifies each thread's stack size in bytes, “deque_size” specifies each thread's deque size in bytes and “stack_limit” specifies an upper bound on the number of bytes of stack space mapped by each thread. In some embodiments, a default value may be used if an argument equals 0. Descriptions of these arguments and their default values are included in the programming interface reference description below, according to one embodiment. In this example, the calls to the functions tlp_spawn_root( ) and tlp_sync_root( ) on lines 5 and 6 respectively spawn and sync the computation.

Pseudo code example 8: Load balancer declaration and
computation in C

1 tlp_balancer_base_t s;
2 tlp_balancer_create(&s, threads, stack_size,
deque_size, stack_limit);
3 merge_sort_t a;
4 merge_sort_create(&a, first, last);
5 tlp_spawn_root(&s, merge_sort_run, &a.arg);
6 tlp_sync_root(&s);
7 tlp_balancer_destroy(&s);

In some embodiments, a call to the function tlp_spawn_root( ) followed immediately by a call to tlp_sync_root( ), as on lines 5 and 6 in pseudo code example 8, may be replaced by a single call to the function tlp_spawn_sync_root( ). In such embodiments, the function tlp_spawn_sync_root( ) may take the same arguments as the function tlp_spawn_root( ) it replaces.

In some embodiments, the tlp_balancer_base_t creation and destruction functions tlp_balancer_create( ) and tlp_balancer_destroy( ) may have a relatively large time overhead. In such embodiments, to amortize this overhead across a series of computations, an instance of tlp_balancer_base_t may be reused multiple times by repeatedly calling the function tlp_spawn_sync_root( ) or the functions tlp_spawn_root( ) and tlp_sync_root( ) in strict alternation.

The system described herein may in some embodiments guarantee the same shared-memory consistency model generally provided by the multi-core processor(s) on which it runs, and the C/C++ compiler employed. In some embodiments, the system may also guarantee two additional properties on shared-memory consistency. First, that updates to shared-memory issued by a parent before that parent spawns a child can be correctly observed by that child. Second, that updates to shared-memory issued by a child can be correctly observed by the parent that spawned that child after that parent runs a subsequent sync.

In some embodiments, the software thread executing a function before that function syncs (i.e. before it calls the function tlp_sync( ), tlp_spawn_sync( ), or tlp_spawn_sync_branch( )) may differ from the software thread executing that function after the sync returns. As a result, the use of sync may impact thread safety. For example, two references to operating system thread local storage within a function may result in different variables being accessed if a sync occurs between the two references. Similarly, global state employed by C and C++ standard library facilities, such as the variable “ermo” as well as the state used by the functions rand( ) and strtok( ), may in general not be maintained across a sync. Another example of potential difficulty may be the use of a software service that relies on invariant operating system thread identifiers for proper operation, such as the Microsoft® Foundation Class Library (MFC) and the Windows™ API critical section objects (CRITICAL_SECTION). Therefore, in some embodiments, the use of sync may be precluded in sections of code that require software thread invariance. In some embodiments, the load balancer described herein may not be thread safe. Therefore, in some embodiments, calls by multiple client threads to the load balancer functions of a single load balancer instance (ie, tlp_spawn_root( ), tlp_sync_root( ), tlp_spawn_sync_root( ), etc) must be serialized by the client.

In some embodiments, the system described herein may provide partial support for C++ exceptions. In such embodiments, exception usage may need to abide by the following three rules. First, a function may throw an exception provided that the lifetime requirements of all unwound spawned functor class instances are satisfied. Second, a function may not sync (i.e. call the function tlp_sync( ), tlp_spawn_sync( ), or tlp_spawn_sync_branch( )) in the catch clause of a try-catch statement. Third, a function may not sync in the destructor of an automatic variable during exception stack unwinding (i.e. if the function std::uncaught_exception( ) returns nonzero when called by the destructor).

In some embodiments, the function tlp_skip_sync( ) may perform a variant of the sync operation and may be used in the catch clause of a try-catch statement and in the destructor of an automatic variable without restriction. This function may not guarantee that all of a parent's spawned children are run, but it may guarantee that all of a parent's spawned children that have begun to run have returned. The use of the function tlp_skip_sync( ) may compromise the scalability achieved by the system, but this disadvantage may not be important in exception handling situations.

The program fragment in pseudo code example 9 illustrates an example of a call to a function tlp_skip_sync( ). In this example, the functor class instance a is respectively declared, spawned, and synced on lines 2, 3 and 11. In this example, the function f( ) called on line 5 may throw an exception. In some embodiments, if no try-catch statement were included in the fragment, the lifetime requirement of the instance a may not be satisfied if f( ) were to throw an exception. To satisfy the lifetime requirement, a try-catch statement may be included and the function tlp_skip_sync( ) may be called in its catch clause, as shown on line 8. In this example, after tlp_skip_sync( ) returns, the exception may be safely re-thrown.

Pseudo code example 9: Example of tlp_skip_sync( )

| | |
|---|---|
| 1 | { |
| 2 | fun_t a; |
| 3 | tlp_spawn(a); |
| 4 | try { |
| 5 | f( ); |
| 6 | } |
| 7 | catch (...) { |
| 8 | tlp_skip_sync( ); |
| 9 | throw; |
| 10 | } |
| 11 | tlp_sync( ); |
| 12 | } |

Note that when an exception is thrown by the function f( ) in pseudo code example 9, the spawn a may or may not have been run. In some embodiment, to guarantee that spawn a is run, the function tlp_sync( ) may not be used in place of tlp_skip_sync( ) in the catch clause due to the restrictions described above. Instead, the catch clause may set a flag and then exit the catch clause normally without re-throwing the exception. After the subsequent call to tlp_sync( ), which may guarantee that spawn a is run, a new exception may be thrown if the flag is set.

In some embodiments, the use of the try-catch statement in pseudo code example 9 may be avoided by declaring an instance of the guard tlp_skip_sync_guard after the declaration of the instance of the functor a, as shown in pseudo code example 10. In this example, the destructor of the guard g may call the function tlp_skip_sync( ) if the function std::uncaught_exception( ) returns nonzero. By declaring guard g after functor a, the function tlp_skip_sync( ) may be called before the lifetime of functor a ends when an exception is thrown by function f( ).

Pseudo code example 10: Example of tlp_skip_sync_guard

| | |
|---|---|
| 1 | { |
| 2 | fun_t a; |
| 3 | tlp_skip_sync_guard g; |
| 4 | tlp_spawn(a); |
| 5 | f( ); |
| 6 | tlp_sync( ); |
| 7 | } |

In some embodiments, exceptions thrown by spawned children may be handled as follows. If one or more of a parent's spawned children throws an exception, an exception of the class tlp_exception_t may be thrown by the parent when the parent executes the subsequent sync. The data member error of the parent thrown tlp_exception_t may be defined as follows. A set of exceptions thrown by the parent's spawned children may be formed. A single representative from this set may be selected arbitrarily. If this representative is an instance of class tlp_exception_t, the data member error of the parent thrown tlp_exception_t may equal the value of the data member error of the representative. If this representative is an instance of class std::bad_alloc the data member error of the parent thrown tlp_exception_t may equal a value ENOMEM, indicating a failure to appropriately allocate memory. Otherwise, the data member error of the parent thrown tlp_exception_t may equal EINVAL, indicating an unspecified system specific error.

### Programming Interface Reference

As previously noted, the system and methods described herein may employ various library functions to manage load balancing for fully strict thread-level parallelism. The following pseudo code examples (based on the C programming language) may represent various library functions and/or type definitions included in the system to support the methods described herein, according to various embodiments.

A function tlp_balancer_configure( ), illustrated below, may in some embodiments be used to tune load balancer performance on a particular multi-core processor by specifying values for certain exponential back-off and patience parameters.

```
int tlp_balancer_configure(
  int cas_backoff_base,
  int cas_backoff_limit,
  int steal_backoff_base,
  int steal_backoff_limit,
  int sync_patience
);
```

In some embodiments, if the function tlp_balancer_configure( ) is called, it must be called exactly once prior to calls to the function tlp_balancer_create( ). The parameters cas_backoff_base and cas_backoff_limit may specify, respectively, the minimum and maximum exponential backoff delays in time stamp units used by atomic compare-and-swap operations. In some embodiments, default values of these parameters may be 65 and 16384, respectively. The parameters steal_backoff_base and steal_backoff_limit may specify, respectively, the minimum and maximum exponential back-off delays in time stamp units used by a thief thread when its steal attempt fails. In some embodiments, default values of these parameters may be 256 and 16384, respectively. The parameter sync_patience may specify a patience in time stamp units that a thief thread will delay before it exits its stealing loop and blocks waiting for a new parallel computation to be started. In some embodiments, the default value of this parameter may be 65536. If successful, the tlp_balancer_configure( ) function may return 0. Otherwise, a nonzero error number may be returned to indicate the error. In some embodiments, and for various ones of the functions described herein, a return of the EINVAL error may indicate an unspecified system specific error.

A function tlp_default_threads( ) may return the maximum number of hardware threads that could be available this boot of the multicore.

A function tlp_default_stack_size( ) may return the default stack size in bytes of each software thread scheduled by the load balancer. In some embodiments, this value may be guaranteed to be at least 512 kilobytes for 32-bit processes and 1,024 kilobytes for 64-bit processes may in some embodiments be on the order of several megabytes per stack

A function tlp_default_deque_size( ) may return the default deque size in bytes of each software thread scheduled by the load balancer. In some embodiments, this value may be guaranteed to be at least 16 kilobytes for 32-bit processes and 32 kilobytes on 64-bit processes may in some embodiments be dependent on how many nested function calls can occur, thus max number of spawns that can occur—usually several megabytes for deque (can be determined, at least in part, by static code analysis and/or testing)

A function tlp_default_stack_limit( ) may return the default upper bound on the number of bytes of stack space mapped by each software thread scheduled by the load balancer. In some embodiments, this value may be guaranteed to be at least eight times the value returned by tlp_default_stack_size( ).

An opaque type tlp_argument_t may contain load balancer state information, in some embodiments. In some such embodiments, a data member of type tlp_argument_t must be included in the functor struct associated with a spawned function.

In some embodiments, an instance of the opaque type tlp_balancer_base_t must be declared to create an instance of the load balancer and run a computation.

A type tlp_function_base_t may declare the signature type for a function that can be spawned. The function may take as argument a pointer to a data member of type tlp_argument_t of a functor struct instance. In some embodiments, the function may returns 0 if successful, and may return a nonzero error number otherwise.

As described above, a function tlp_balancer_create( ) may create an instance of a load balancer. In some embodiments, the first argument may be a pointer to an instance of the type tlp_balancer_base_t to be created. An argument “threads” may specify the number of software threads that will participate in a computation. In some embodiments, if 0 is specified, the value returned by the function tlp_default_threads( ) may be used. An argument “stack_size” may specify each software thread's stack size in bytes. In some embodiments, if 0 is specified, the value returned by the function tlp_default_stack_size( ) may be used. In some embodiments, one physical page of a stack may be reserved by the load balancer as a guard to detect stack overflow. In some embodiments, up to 16 kilobytes of a stack may be reserved by the load balancer as an offset to reduce non-fully associative cache aliasing. An argument “deque_size” may specify each software threads's deque size in bytes. In some embodiments, if 0 is specified, the value returned by the function tlp_default_deque_size( ) may be used. An argument “stack_limit” may specify an upper bound on the number of bytes of stack space mapped by each software thread. In some embodiments, if 0 is specified, the value returned by the function tlp_default_stack_limit( ) may be used. In some embodiments, the value of stack_limit must be at least twice the value of stack_size.

In some embodiments, if a thread requires more stack space than specified by the stack_size argument, the computation may terminate due to stack overflow. Similarly, if a thread requires more deque space than that specified by the deque_size argument, the scalability achieved by the load balancer may be compromised. In addition, if a thread requires more mapped stack space than that specified by the stack_limit argument, the scalability achieved by the load balancer may be compromised. The function tlp_performance( ) may in some embodiments be used to determine if a thread exceeded any of the deque or stack limits. Note that in some embodiments, a conservative upper bound on the deque size required by a thread may be computed by forming the product of the following three factors: the maximum nested parent/child spawn depth, the maximum number of children spawned by any parent, and the value of sizeof(void*).

In some embodiments, if successful, the tlp_balancer_create( ) function may return 0. Otherwise, a nonzero error number may be returned to indicate the error. For example, in one embodiment the EAGAIN error may indicate that the system lacked necessary resources (other than memory), the NOMEM error may indicate that the system lacked the necessary memory, and the EINVAL error may indicate an unspecified system specific error.

A function tlp_balancer_destroy( ) may destroy an instance of the load balancer. An argument to the function may be a pointer to an instance of the type tlp_balancer_base_t previously created by a call to the function tlp_balancer_create( ). In some embodiments, if successful, the tlp_balancer_destroy( ) function may return 0. Otherwise, a nonzero error number may be returned to indicate the error.

A function tlp_spawn_root( ) may spawn a computation. The first argument may be a pointer to an instance of the type tlp_balancer_base_t previously created by a call to the function tlp_balancer_create( ). An argument f may be a pointer to the function to spawn. A argument a may be a pointer to the tlp_argument_t data member of an associated functor struct instance. In some embodiments, the lifetime of the functor struct instance must persist until after the subsequent call to the function tlp_sync_root( ). In some embodiment, if successful, the tlp_spawn_root( ) function may return 0. Otherwise, a nonzero error number may be returned to indicate the error.

A function tlp_sync_root( ) may sync a computation previously spawned by the function tlp_spawn_root( ). In some embodiments, the function tlp_sync_root( ) may suspend its caller until the computation has returned. An argument to this function may be a pointer to an instance of the type tlp_balancer_base_t passed to the previous call of tlp_spawn_root( ).

In some embodiments, if successful, the tlp_sync_root( ) function may return the value returned by the spawned function. Otherwise, a nonzero error number may be returned to indicate the error.

As described above, a function tlp_spawn_sync_root( ) may be an optimized equivalent to a call to the function tlp_spawn_root( ) followed immediately by a call to the function tlp_sync_root( ). In some embodiments, the function tlp_spawn_sync_root( ) may take the same arguments as the function tlp_spawn_root( ) it replaces. In some embodiments, if successful, the tlp_spawn_sync_root( ) function may return the value returned by the spawned function. Otherwise, a nonzero error number may be returned to indicate the error.

A function tlp_completed_root( ) may return nonzero if the computation previously spawned by the function tlp_spawn_root( ) has returned. Otherwise, 0 may be returned to indicate that the computation has not returned. In some embodiments, if tlp_completed_root( ) returns nonzero, a call of the function tlp_sync_root( ) may not suspends its caller. An argument to this function may be a pointer to an instance of the type tlp_balancer_base_t passed to the previous call of tlp_spawn_root( ).

A function call tlp_spawn_sync_branch(s, f, a) may be equivalent to the call tlp_spawn_sync_root(s, f, a) if the call to the function tlp_completed_root(s) would return nonzero. Otherwise, the call tlp_spawn_sync_root(s, f, a) may be equivalent to the call tlp_spawn_sync(tlp_argument( ), f, a).

As described above, in some embodiments one or more load balancer performance counters may be used to track the adoption and completion of spawned children. In such embodiments, a function tlp_performance( ), such as that described below, may return the value of such a performance counter.

typedef enum {tlp_steals_completed, tlp_adoptions_completed,
tlp_adoptions_stalled, tlp_spawns_stalled}
tlp_performance_t;
size_t tlp_performance(tlp_balancer_base_t* s, tlp_performance_t t);

In this example, the function tlp_performance( ) may return the value of a load balancer performance counter. The first argument may be a pointer to an instance of the type tlp_balancer_base_t previously created by a call to the function tlp_balancer_create( ). An argument t may specify a particular performance counter. In some embodiments, it must be equal to one of the constants defined by the enum tlp_performance_t, as shown above.

In some embodiments, the value of the performance counter tlp_steals_completed may equal the number of spawned children run by a thread different that the thread that ran the spawning parent; the value of the performance counter tlp_adoptions_completed may equal the number of times that the thread running a spawned child adopted a stack abandoned by the thread that ran the child's parent; the value of the performance counter tlp_adoptions_stalled may equal the number of times that the computation attempted to exceed the stack limit specification entailed in the tlp_balancer_create( ) call plus the number of times the computation stalled by calls to the function tlp_skip_sync( ); and the value of the performance counter tlp_spawns_stalled may equal the number of times that the computation attempted to exceed the deque size specification entailed in the tlp_balancer_create( ) call. In some embodiments, a nonzero returned value may indicate that the scalability of the computation may be improved with a larger stack limit specification, with a larger deque size specification, or by fewer calls to the function tlp_skip_sync( ).

A function tlp_spawn( ) may spawn a child function that may run in parallel with the calling parent function. An argument u may be a pointer to the tlp_argument_t passed as argument to the calling parent. An argument f may be a pointer to the function to spawn. An argument a may be a pointer to the tlp_argument_t data member of an associated functor struct instance. In some embodiments, the lifetime of the functor struct instance must persist until after the subsequent call to the function tlp_sync( ), tlp_skip_sync( ) or tlp_spawn_sync( ). In this example, the function pointed to by argument f may be called with an argument a. In some embodiments, if successful, the tlp_spawn( ) function may return 0. Otherwise, a nonzero error number may be returned to indicate the error.

A function tlp_sync( ) may suspend the calling parent until all of its spawned children have returned. An argument u may be a pointer to the tlp_argument_t passed as argument to the calling parent. In some embodiments, the function tlp_sync( ) may be thread variant. In some embodiment, if successful, and if all of the parent's spawned children returned 0, the tlp_sync( ) function may return 0. If successful, and if one or more of the parent's spawned children returned nonzero, the tlp_sync( ) function may return a nonzero error number equal to one of the nonzero error numbers returned by the children (e.g., selected arbitrarily). Otherwise, a nonzero error number may be returned to indicate the error.

A function tlp_skip_sync( ) may suspend the calling parent until all of its spawned children that have been stolen have returned. The function may not guarantee that its unstolen spawned children have run, in some embodiments. An argument u may be a pointer to the tlp_argument t passed as argument to the calling parent. The function tlp_skip_sync( ) may be thread invariant. The function tlp_skip_sync( ) may return a result defined in the same way as the result returned by the function tlp_sync( ).

A function tlp_spawn_sync( ) may be an optimized equivalent to a call to the function tlp_spawn( ) followed immediately by a call to the function tlp_sync( ). The function tlp_spawn_sync( ) may take the same arguments as the function tlp_spawn( ) it replaces. The function tlp_spawn_sync( ) may be thread variant. In some embodiments, the tlp_spawn_sync( ) function may return the same result as the function tlp_sync( ) it replaces.

A function tlp_threads( ) may return the number of software threads participating in the computation. An argument u may be a pointer to the tlp_argument_t passed as argument to the calling parent.

A function tlp_identifier( ) may return an integer that uniquely identifies the software thread that called tlp_identifier( ). The value of the returned integer i may satisfy the following constraint: 0≦i<tlp_threads(u). An argument u may be a pointer to the tlp_argument_t passed as argument to the calling parent.

A function tlp_stolen( ) may return nonzero if the software thread that called tlp_stolen( ) differs from the thread that ran the spawning parent, and may return 0 otherwise. In some embodiments, function tlp_stolen( ) may return 0 when called by the root function. An argument u may be a pointer to the tlp_argument_t passed as argument to the calling parent.

A function tlp_balancer( ) may return a pointer to the associated load balancer instance. An argument u may be a pointer to the tlp_argument_t passed as argument to the calling parent.

A function tlp_stack_used( ) may return an upper bound on the amount of stack space used by the calling software thread. An argument u may be a pointer to the tlp_argument_t passed as argument to the calling parent.

A function tlp_deque_used( ) may return an upper bound on the amount of deque space used by the calling software thread. An argument u may be a pointer to the tlp_argument_t passed as argument to the calling parent.

In some embodiments, with the aid of operating system thread local storage, the function tlp_argument( ) may return the tlp_argument_t pointer argument of the calling spawned function. In some embodiments, the function tlp_argument( ) may be defined and may be called only by software threads created by the load balancer or by the software thread that called the function tlp_spawn_sync_root( ) or tlp_spawn_sync_branch( ).

The following pseudo code examples (based on the C++ programming language) may represent various library functions and/or type definitions included in the system to support the methods described herein, according to various embodiments. In some embodiments, library functions based on the C++ programming language may be identical or similar to those presented above and based on the C programming language. For example, a C++ based library may include functions similar to tlp_default_threads; tlp_default_stack_size; tlp_default_deque_size; and tlp_default_stack_limit, described above.

In embodiments in which library function are based on C++, all of the C and/or C++ declarations may reside in a single namespace comprising the functions supporting fully strict thread-level parallelsim. Various functions and classes that may be included in such a library are represented by the following pseudo code examples.

A class tlp_exception_t, shown below, may define the exception thrown by certain thread-level parallelism-related library functions. In this example, the constructor may accept an error number argument that is saved in the publically accessible data member error.

```
class tlp_exception_t {
  tlp_exception_t(int error = EINVAL);
  int error;
};
```

An instance of a class tlp_balancer_t (shown below) must in some embodiments be declared to create an instance of the load balancer and run a computation. In some embodiments, the member functions may operate equivalently to similarly named functions in the C based programming interface descriptions above.

```
class tlp_balancer_t {
  int tlp_balancer_create(int threads, size_t stack_size,
    size_t deque_size, size_t stack_limit);
  int tlp_balancer_destroy( );
  int tlp_spawn_root(tlp_function_t& f);
  int tlp_sync_root( );
  int tlp_spawn_sync_root(tlp_function_t& f);
  int tlp_completed_root( );
  int tlp_spawn_sync_branch(tlp_function_t& f);
  size_t tlp_performance(tlp_performance_t t);
};
```

In this example, the functions tlp_spawn_root( ), tlp_spawn_sync_root( ) and tlp_spawn_sync_branch( ) may take as argument a reference to an instance of a functor class derived from the base class tlp_function_t. In this example, the functions tlp_spawn_root( ), tlp_spawn_sync_root( ) and tlp_spawn_sync_branch( ) may throw the exception tlp_exception_t.

A class tlp_function_t may provide a base class for a functor class whose instances can be spawned. The virtual member function tlp_run( ) may implement the function. In some embodiments, if successful, the tlp_run( ) must return 0. Otherwise, it must return a nonzero error number. In some embodiments, the non-virtual, non-static member functions listed below may operate equivalently to those similarly named functions in the C based programming interface descriptions above.

virtual int tlp_run( ) = 0;
int tlp_spawn(tlp_function_t& f);
int tlp_sync( );
int tlp_skip_sync( );
int tlp_spawn_sync(tlp_function_t& f);
int tlp_threads( );
int tlp_identifier( );
int tlp_stolen( );
tlp_balancer_t* tlp_balancer( );
size_t tlp_stack_used( );
size_t tlp_deque_used( );
static tlp_function_t* tlp_function( );

};

In this example, the member functions tlp_spawn( ) and tlp_spawn_sync( ) may take as argument a reference to an instance of a functor class derived from the base class tlp_function_t. The functions tlp_sync( ), tlp_skip_sync( ) and tlp_spawn sync( ) may throw the exception tlp_exception_t.

In some embodiments, with the aid of operating system thread local storage, the static member function tlp_function( ) may return a pointer to the functor class instance of the calling spawned function. In some embodiments, the function tlp_argument( ) may be defined by and may be called only by software threads created by the load balancer or by the software thread that called the member function tlp_balancer_t::tlp_spawn_sync_root( ) or tlp_balancer_t::tlp_spawn_sync_branch( ).

In some embodiments, a destructor of the class tlp_skip_sync_guard (shown below) may call the function tlp_skip_sync( ) if the function std::uncaught_exception( ) returns nonzero. In some embodiments, the guard may be used to guarantee the lifetime requirements of spawned functor class instances. If guard is constructed with an argument e, and if e equals 0 when the destructor is called, then e may be set equal to the result returned by the call to tlp_skip_sync( ).

```
class tlp_skip_sync_guard {
  tlp_skip_sync_guard( );
  tlp_skip_sync_guard(int& e);
};
```

Some embodiments of the system described herein may include a means for spawning child functions suitable to be executed in parallel. For example, a spawn module may push a stack frame element associated with a spawned child function onto a double-ended queue (deque) that is associated with an executing thread and that is configured to record spawns of the executing thread, as described in detail herein. The spawn module may in some embodiments be implemented by a computer-readable storage medium and one or more processors (e.g., CPUs and/or GPUs) of a computing apparatus. The computer-readable storage medium may store program instructions executable by the one or more processors to cause the computing apparatus to perform pushing a stack frame element associated with a spawned child function onto a double-ended queue (deque) that is associated with an executing thread and that is configured to record spawns of the executing thread, as described in detail herein. Other embodiments of the spawn module may be at least partially implemented by hardware circuitry and/or firmware stored, for example, in a non-volatile memory.

Some embodiments of the system described herein may include a means for syncing functions that have been spawned for execution in parallel. For example, a sync module may determine whether any of the stack frame elements associated with spawned children of a calling parent remain in a spawn/sync deque. If at least one of the spawned children remains in the double-ended queue, the sync module may cause the calling parent to remove one or more of the stack frame elements associated with the spawned children and to execute the children associated with the removed stack frame elements. Once no more spawned children remain in the deque, the sync module may cause the executing thread to continue execution beyond the corresponding sync, or, if any stolen children have not yet returned, to abandon its call/return stack as an orphan stack, acquire a new call/return stack, and attempt to steal work from other threads, as described in detail herein. The sync module may in some embodiments be implemented by a computer-readable storage medium and one or more processors (e.g., CPUs and/or GPUs) of a computing apparatus. The computer-readable storage medium may store program instructions executable by the one or more processors to cause the computing apparatus to perform determining whether any of the stack frame elements associated with spawned children of a calling parent remain in a spawn/sync deque. If at least one of the spawned children remains in the double-ended queue, the sync module may cause the computing apparatus to perform removing one or more of the stack frame elements associated with the spawned children and executing the children associated with the removed stack frame elements. Once no more spawned children remain in the deque, the sync module may cause the computing apparatus to perform continuing execution of the executing thread beyond the corresponding sync, or, if any stolen children have not yet returned, abandoning the current call/return stack as an orphan stack, acquiring a new call/return stack, and attempting to steal work from other threads, as described in detail herein. Other embodiments of the sync module may be at least partially implemented by hardware circuitry and/or firmware stored, for example, in a non-volatile memory.

Some embodiments of the system described herein may include a means for performing load balancing between threads executing in parallel. For example, a load balancing module may distribute work among concurrently executing threads, as described in detail herein. The load balancing module may in some embodiments be implemented by a computer-readable storage medium and one or more processors (e.g., CPUs and/or GPUs) of a computing apparatus. The computer-readable storage medium may store program instructions executable by the one or more processors to cause the computing apparatus to perform distributing work among concurrently executing threads, as described in detail herein. Other embodiments of the load balancing module may be at least partially implemented by hardware circuitry and/or firmware stored, for example, in a non-volatile memory.

Some embodiments of the system described herein may include a means for performing other functions that support the execution of fully strict thread-level parallel programs and load balancing between concurrently executing threads. For example, various load balancing support modules may create or destroy an executable instance of the load balancing module, return a number of available hardware threads, return a default stack size or upper bound on stack space, return a default deque size or upper bound on deque space, return an integer that uniquely identifies a calling thread, return a pointer to a load balancer instance, return a pointer of a calling or spawned function, or return the value of a load balancer performance counter, as described in detail herein. The load balancing support modules may in some embodiments be implemented by a computer-readable storage medium and one or more processors (e.g., CPUs and/or GPUs) of a computing apparatus. The computer-readable storage medium may store program instructions executable by the one or more processors to cause the computing apparatus to perform creating or destroying an executable instance of the load balancing module, returning a number of available hardware threads, returning a default stack size or upper bound on stack space, returning a default deque size or upper bound on deque space, returning an integer that uniquely identifies a calling thread, returning a pointer to a load balancer instance, returning a pointer of a calling or spawned function, or returning the value of a load balancer performance counter, as described in detail herein. Other embodiments of the load balancing support modules may be at least partially implemented by hardware circuitry and/or firmware stored, for example, in a non-volatile memory.

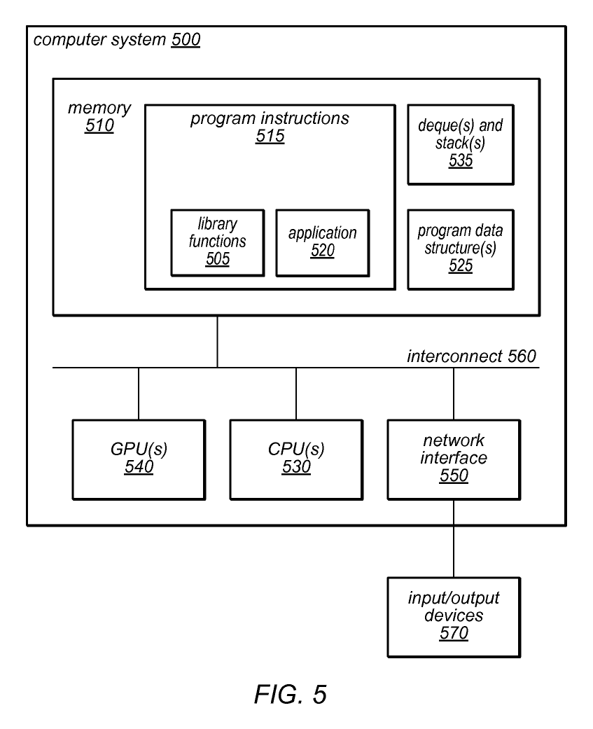

The methods described herein for executing fully strict thread-level parallel programs and performing load balancing between concurrently executing threads may in some embodiments be implemented by a computer system configured to provide the functionality described. FIG. 5 is a block diagram illustrating one embodiment of a computer system 500 configured to implement the parallel program execution and load balancing techniques described herein. Computer system 500 may be any of various types of devices, including, but not limited to, a personal computer system, desktop computer, laptop or notebook computer, mainframe computer system, handheld computer, workstation, network computer, a consumer device, video game console, handheld video game device, application server, storage device, a peripheral device such as a switch, modem, router, or in general any type of computing device.

As illustrated in FIG. 5, computer system 500 may include one or more processor units (CPUs) 530. Processors 530 may be implemented using any desired architecture or chip set, such as the SPARC™ architecture, an x86-compatible architecture from Intel Corporation or Advanced Micro Devices, or another architecture or chipset capable of processing data, and may in various embodiments include multiple processors, a single threaded processor, a multi-threaded processor, a multi-core processor, or any other type of general-purpose or special-purpose processor. In various embodiments, the methods disclosed herein for executing fully strict thread-level parallel programs and performing load balancing between concurrently executing threads may be implemented by program instructions configured to spawn functions (e.g., functions included in application 520 and/or library functions 505 in FIG. 5) for parallel execution on two or more such CPUs. For example, spawned functions for performing image editing operations may be distributed for independent and/or concurrent execution on two or more of CPUs 530, or on multiple processing cores of a single CPU 530, in some embodiments. Any desired operating system(s) may be run on computer system 500, such as various versions of Unix, Linux, Windows™ from Microsoft Corporation, MacOS™ from Apple Corporation, or any other operating system that enables the operation of software on a hardware platform.

As illustrated in FIG. 5, computer system 500 may also include one or more graphics processing units (GPUs) 540. A GPU may be considered a dedicated graphics-rendering device for a personal computer, workstation, game console or other computer system. Modern GPUs may be very efficient at manipulating and displaying computer graphics and their highly parallel structure may make them more effective than typical CPUs for a range of complex graphical algorithms. For example, a GPU 540 may implement a number of graphics primitive operations in a way that makes executing them much faster than drawing directly to the screen with a host CPU, such as CPU 530. In various embodiments, the methods disclosed herein for executing fully strict thread-level parallel programs and performing load balancing between concurrently executing threads may be implemented by program instructions configured to spawn functions for parallel execution on two or more such GPUs. For example, spawned functions for performing image editing using graphics primitive operations may be distributed for independent and/or concurrent execution on two or more GPUs, in some embodiments. The GPU 540 may implement one or more application programmer interfaces (APIs) that permit programmers to invoke the functionality of the GPU. Suitable GPUs may be commercially available from vendors such as NVIDIA Corporation, ATI Technologies, and others.

GPUs, such as GPU 540 may be implemented in a number of different physical forms. For example, GPU 540 may take the form of a dedicated graphics card, an integrated graphics solution and/or a hybrid solution. GPU 540 may interface with the motherboard by means of an expansion slot such as PCI Express Graphics or Accelerated Graphics Port (AGP) and thus may be replaced or upgraded with relative ease, assuming the motherboard is capable of supporting the upgrade. However, a dedicated GPU is not necessarily removable, nor does it necessarily interface the motherboard in a standard fashion. The term “dedicated” refers to the fact that hardware graphics solution may have RAM that is dedicated for graphics use, not to whether the graphics solution is removable or replaceable. Dedicated GPUs for portable computers may be interfaced through a non-standard and often proprietary slot due to size and weight constraints. Such ports may still be considered AGP or PCI express, even if they are not physically interchangeable with their counterparts.

Integrated graphics solutions, or shared graphics solutions are graphics processors that utilize a portion of a computer's system RAM rather than dedicated graphics memory. For instance, modern desktop motherboards normally include an integrated graphics solution and have expansion slots available to add a dedicated graphics card later. As a GPU may be extremely memory intensive, an integrated solution may find itself competing for the already slow system RAM with the CPU, as the integrated solution has no dedicated video memory. For instance, system RAM may experience a bandwidth between 2 GB/s and 8 GB/s, while most dedicated GPUs enjoy from 15 GB/s to 30 GB/s of bandwidth. Hybrid solutions may also share memory with the system memory, but may have a smaller amount of memory on-board than discrete or dedicated graphics cards to make up for the high latency of system RAM. Data communicated between the GPUs 540 and the rest of the computer system 500 may travel through a graphics card slot or other interface, such as interconnect 560 of FIG. 5.

As illustrated in FIG. 5, computer system 500 may include one or more system memories 510 (e.g., one or more of cache, SRAM, DRAM, RDRAM, EDO RAM, DDR RAM, SDRAM, Rambus RAM, EEPROM, or other memory type), or other types of RAM or ROM) coupled to other components of computer system 500 via interconnect 560. Memory 510 may include other types of memory as well, or combinations thereof. In the example illustrated in FIG. 5, memory 510 may represent any of various types and arrangements of memory, including general-purpose system RAM and/or dedication graphics or video memory.

One or more of memories 510 may include program instructions 515 executable by one or more of CPUs 530 and/or GPUs 540 to implement aspects of parallel program execution and/or the load balancing techniques described herein. Program instructions 515, which may include program instructions configured to implement application 520, may be partly or fully resident within the memory 510 of computer system 500 at any point in time. Alternatively, program instructions 515 may be provided to GPU 540 (e.g., as spawned functions) for performing graphics operations on GPU 540 using one or more of the techniques described herein. In some embodiments, the techniques described herein may be implemented by a combination of program instructions 515 executed on one or more CPUs 530 and one or more GPUs 540, respectively. In this example, application 520 may be configured for fully strict thread-level parallelism. In other words, it may include parallelizable (i.e. spawnable) operations, such as the image editing operations or search operations described herein. In embodiments in which application 520 comprises an image editing application, application 520 may be configured to render modified images to a separate window, or directly into the same frame buffer containing an input image. In some embodiments, application 520 may utilize a GPU 540 when rendering or displaying images according to various embodiments. Application 520 may represent (or be a module of) various types of graphics applications, such as painting, publishing, photography, games, or animation applications, or may represent (or be a module of) another type of application. Please note that functionality and/or features described herein as being part of, or performed by, application 520 may, in some embodiments, be part of, or performed by, one or more graphics processors, such as GPU 540.

As illustrated in FIG. 5, program instructions 515 may in some embodiments include various library functions 505, such as the library functions described herein for supporting fully strict thread-level parallelism and/or load balancing of concurrently execution threads (e.g., a load balancing function, a sync function, and a spawn function). Various ones of these library functions 505 may be executable on one or more of CPUs 530 and/or GPUs 540 to cause computer system 500 to provide the functionality described herein.

Program instructions 515 may be stored on an external storage device (not shown) accessible by CPUs 530 and/or GPUs 540, in some embodiments. Any of a variety of such storage devices may be used to store the program instructions 515 in different embodiments, including any desired type of persistent and/or volatile storage devices, such as individual disks, disk arrays, optical devices (e.g., CD-ROMs, CD-RW drives, DVD-ROMs, DVD-RW drives), flash memory devices, various types of RAM, holographic storage, etc. The storage devices may be coupled to the CPUs 530 and/or GPUs 540 through one or more storage or I/O interfaces including, but not limited to, interconnect 560 or network interface 550, as described herein. In some embodiments, the program instructions 515 may be provided to the computer system 500 via any suitable computer-readable storage medium including memory 510 and/or external storage devices described above.

As illustrated in FIG. 5, memory 510 may be configured to implement one or more program data structures 525, such as one or more data structures configured to store data representing one or more input images, output images, or intermediate images for a graphics application, or other types of program data for other applications. As illustrated in FIG. 5, memory 510 may also include various spawn/sync deques, call/return stacks, and additional stacks (e.g., stacks usable as orphan stacks) for one or more threads of execution. These are shown as deques and stacks 535. Program data structures 525 and/or deques and stacks 535 may be accessible by CPUs 530 and/or GPUs 540 when executing application 520, library functions 505, or other program instructions with program instructions 515.

Application 520 and/or library functions 505 may be provided as a computer program product, or software, that may include a computer-readable storage medium having stored thereon instructions, which may be used to program a computer system (or other electronic devices) to implement executing fully strict thread-level parallel programs and performing load balancing between concurrently executing threads, as described herein. A computer-readable storage medium may include any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto optical storage medium; read only memory (ROM); random access memory (RAM); erasable programmable memory (e.g., EPROM and EEPROM); flash memory; electrical, or other types of medium suitable for storing program instructions. In addition, program instructions may be communicated using optical, acoustical or other form of propagated signal (e.g., carrier waves, infrared signals, digital signals, or other types of signals or mediums.).

As noted above, in some embodiments, memory 510 may include program instructions 515, comprising program instructions configured to implement an application 520 and/or library functions 505, as described herein. Application 520 and/or library functions 505 may be implemented in various embodiments using any desired programming language, scripting language, or combination of programming languages and/or scripting languages, e.g., C, C++, C#, Java™, Perl, etc. For example, in one embodiment, application 520 and/or library functions 505 may be JAVA based, while in another embodiments, they may be implemented using the C or C++ programming languages. In other embodiments, all or a portion of application 520 and/or any of library functions 505 may be implemented using specific graphic languages specifically for developing programs executed by specialize graphics hardware, such as GPU 540. In addition, all or a portion of application 520 and/or any of library functions 505 may be embodied on memory specifically allocated for use by GPUs 540, such as memory on a graphics board including GPUs 540. Thus, memory 510 may represent dedicated graphics memory as well as general-purpose system RAM, in various embodiments. Other information not described herein may be included in memory 510 and may be used to implement the methods described herein and/or other functionality of computer system 500.

Note that program instructions 515 may be configured to implement application 520 as a stand-alone application configured for fully strict thread-level parallelism, or as a module of another application configured for fully strict thread-level parallelism, in various embodiments. For example, in one embodiment program instructions 515 may be configured to implement graphics applications such as painting, publishing, photography, games, animation, and/or other applications, and may be configured to spawn concurrent functions as part of one or more of these graphics applications. In another embodiment, program instructions 515 may be configured to spawn concurrent functions through one or more parent functions called by a graphics application executed on GPU 540 and/or CPUs 530. Similarly, library functions 505 may in some embodiments be a stand-alone library of functions configured to support fully strict thread-level parallelism and/or load balancing of concurrently execution threads, while in other embodiments library functions 505 may be included in a graphics library or in another general purpose library of functions available to application 520 or other program instructions 515.

As shown in FIG. 5, CPUs 530 and/or GPUs 540 may be coupled to one or more of the other illustrated components by at least one communications bus, such as interconnect 560 (e.g., a system bus, LDT, PCI, ISA, or other communication bus type), and a network interface 550 (e.g., an ATM interface, an Ethernet interface, a Frame Relay interface, or other interface). The CPUs 530, the GPUs 540, the network interface 550, and the memory 510 may be coupled to the interconnect 560. It should also be noted that one or more components of system 500 might be located remotely and accessed via a network.

Network interface 550 may be configured to enable computer system 500 to communicate with other computers, systems or machines, such as across a network. Network interface 550 may use standard communications technologies and/or protocols, and may utilize links using technologies such as Ethernet, 802.11, integrated services digital network (ISDN), digital subscriber line (DSL), and asynchronous transfer mode (ATM) as well as other communications technologies. Similarly, the networking protocols used on a network to which computer system 500 is interconnected may include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP), among other network protocols. The data exchanged over such a network by network interface 550 may be represented using technologies, languages, and/or formats, such as the hypertext markup language (HTML), the extensible markup language (XML), and the simple object access protocol (SOAP) among other data representation technologies. Additionally, all or some of the links or data may be encrypted using any suitable encryption technologies, such as the secure sockets layer (SSL), Secure HTTP and/or virtual private networks (VPNs), the international data encryption standard (DES or IDEA), triple DES, Blowfish, RC2, RC4, RC5, RC6, as well as other data encryption standards and protocols. In other embodiments, custom and/or dedicated data communications, representation, and encryption technologies and/or protocols may be used instead of, or in addition to, the particular ones described above.

Computer system 500 may also include one or more additional I/O interfaces, such as interfaces for one or more user input devices 570, or such devices may be coupled to computer system 500 via network interface 550. For example, computer system 500 may include interfaces to a keyboard, a mouse or other cursor control device, a joystick, or other user input devices 570, in various embodiments. Additionally, the computer system 500 may include one or more displays (not shown), coupled to processors 530 and/or other components via interconnect 560 or network interface 550. Such input/output devices may be configured to allow a user to interact with application 520 to request various operations and/or to specify various parameters, thresholds, and/or other configurable options available to the user when executing application 520. It will be apparent to those having ordinary skill in the art that computer system 500 may also include numerous other elements not shown in FIG. 5.

While various techniques for executing fully strict thread-level parallel programs and performing load balancing between concurrently executing threads have been described herein with reference to various embodiments, it will be understood that these embodiments are illustrative and are not meant to be limiting. Many variations, modifications, additions, and improvements are possible. More generally, various techniques are described in the context of particular embodiments. For example, the blocks and logic units identified in the description are for ease of understanding and are not meant to be limiting to any particular embodiment. Functionality may be separated or combined in blocks differently in various realizations or described with different terminology. In various embodiments, actions or functions described herein may be performed in a different order than illustrated or described. Any of the operations described may be performed programmatically (i.e., by a computer according to a computer program). Any of the operations described may be performed automatically (i.e., without user intervention).

The embodiments described herein are meant to be illustrative and not limiting. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope as defined in the claims that follow.

Although the embodiments above have been described in detail, numerous variations and modifications will become apparent to those skilled in the art once the above disclosure is fully appreciated. It is intended that the following claims be interpreted to embrace all such variations and modifications.

1. A system comprising:
one or more processors; and
a memory coupled to the one or more processors and storing program instructions executable by the one or more processors to implement:
a load balancer configured to distribute work among threads based on a runtime library, the runtime library including function calls comprising spawn and sync keywords; and
a parent function of an executing thread configured to spawn one or more child functions suitable for execution in parallel with the parent function on the one or more processors, wherein spawning a child function comprises pushing a respective stack frame element that represents the spawned child function onto a double-ended queue that is associated with the executing thread and that is further configured to record spawned child functions of the executing thread;
subsequent to spawning the one or more child functions, the parent function further configured to execute a sync function associated with the one or more spawned child functions; and
subsequent to executing the sync function, the executing thread being configured to:
abandon a current call/return stack as an orphan stack;
acquire an empty stack as a new call/return stack; and
steal work from another thread executing in the system.

2. The system of claim 1, wherein executing the sync function comprises determining whether any of the respective stack frame elements that represent the one or more spawned child functions remain in the double-ended queue; and
wherein the abandoning and the stealing are performed in response to determining that none of the one or more spawned child functions remain in the double-ended queue and that not all of the one or more spawned child functions have returned.

3. The system of claim 2,
wherein determining whether any of the respective stack frame elements that represent the one or more spawned child functions remain in the double-ended queue is dependent on a value of one or more performance counters; and
wherein the one or more performance counters comprises a counter whose value reflects a number of the one or more spawned child functions executed by a thread other than the thread executing the parent function.

4. The system of claim 1,
wherein executing the sync function comprises determining whether any of the respective stack frame elements that represent the one or more spawned child functions remain in the double-ended queue; and
wherein the parent function is further configured to, prior to the abandoning:
remove one or more respective stack frame elements that represent the one or more spawned child functions; and
execute the respective spawned child functions that are represented by the one or more removed stack frame elements;
wherein the removing and the executing are performed in response to determining that at least one of the one or more spawned child functions remains in the double-ended queue.

5. The system of claim 1, wherein to steal work from another thread comprises:
identifying a stack frame element in a double-ended queue associated with the other thread that represents a spawned child function available for execution;
removing the identified stack frame element from the double-ended queue associated with the other thread; and
executing the spawned child function that is represented by the identified stack frame element.

6. The system of claim 5, wherein to steal work from another thread further comprises:
the executing thread determining whether the spawned child function that is represented by the identified stack frame element is a last spawned child function of a spawning function on an orphan stack of the other thread to be executed; and
in response to determining that the spawned child function that is represented by the identified stack frame element is the last spawned child function of a spawning function on an orphan stack of the other thread to be executed:
the executing thread releasing the new call/return stack;
the executing thread adopting the orphan stack of the other thread as an adopted call/return stack; and
the executing thread continuing execution of the other thread at a point beyond a sync function associated with the last spawned child function.

7. The system of claim 1,
wherein the parent function is further configured to, prior to spawning the one or more child functions, allocate to the executing thread storage space in the memory for two or more stacks;
wherein the two or more stacks comprise the current call/return stack of the executing thread and one or more other call/return stacks; and
wherein acquiring the empty stack as a new call/return stack comprises adopting one of the one or more other call/return stacks allocated to the executing thread.

8. The system of claim 1, wherein the parent function is further configured to, prior to the spawning, allocate to the executing thread storage space in the memory for the double-ended queue.

9. The system of claim 1,
wherein the parent function is further configured to, via the load balancer, execute one or more function calls included in the runtime library; and
wherein spawning the child function comprises invoking execution of at least one of the one or more function calls included in the runtime library to implement pushing the respective stack frame element onto the double-ended queue.

10. The system of claim 9,
wherein executing the sync function is based on execution of the one or more function calls included in the runtime library.

11. The system of claim 1, wherein the one or more processors comprise at least one of a general-purpose central processing unit (CPU) or a graphics processing unit (GPU).

12. One or more computer-readable storage medium storing program instructions that, when executed, direct a computing device to perform acts comprising:
pre-allocating a fixed number of stacks for each executing thread;
a parent function of an executing thread spawning one or more child functions suitable for execution in parallel with the parent function on one or more processors, wherein spawning a child function comprises pushing a respective stack frame element that represents the spawned child function onto a double-ended queue that is associated with the executing thread and that is further configured to record spawned child functions of the executing thread;
subsequent to spawning the one or more child functions, the parent function executing a sync function associated with the one or more spawned child functions; and
subsequent to executing the sync function;
abandoning a current call/return stack as an orphan stack;
acquiring an empty stack as a new call/return stack; and
attempting to steal work from another thread.

13. The one or more computer-readable storage medium of claim 12,
wherein executing the sync function comprises determining whether any of the respective stack frame elements that represent the one or more spawned child functions remain in the double-ended queue; and
wherein the abandoning and the attempting to steal work are performed in response to determining that none of the one or more spawned child functions remain in the double-ended queue and that not all of the one or more spawned child functions have returned.

14. The one or more computer-readable storage medium of claim 12,
wherein executing the sync function comprises determining whether any of the respective stack frame elements that represent the one or more spawned child functions remain in the double-ended queue; and
the acts further comprising, prior to the abandoning:
removing one or more respective stack frame elements that represent the one or more spawned child functions; and
executing the respective spawned child functions that are represented by the one or more removed stack frame elements;
wherein the removing and the executing are performed in response to determining that at least one of the one or more spawned child functions remains in the double-ended queue.

15. The one or more computer-readable storage medium of claim 12, wherein attempting to steal work from another thread comprises:
identifying a stack frame element in a double-ended queue the other thread that represents a spawned child function available for execution;
removing the identified stack frame element from the double-ended queue associated with the other thread; and
executing the spawned child function that is represented by the identified stack frame element.

16. The one or more computer-readable storage medium of claim 15, wherein attempting to steal work from another thread further comprises:
the executing thread determining whether the spawned child function that is represented by the identified stack frame element is a last spawned child function of a spawning function on an orphan stack of the other thread to be executed; and
in response to determining that the spawned child function that is represented by the identified stack frame element is the last spawned child function of a spawning function on an orphan stack of the other thread to be executed:
the executing thread releasing the new call/return stack;
the executing thread adopting the orphan stack of the other thread as an adopted call/return stack; and
the executing thread continuing execution of the other thread at a point beyond a sync function associated with the last spawned child function.

17. The one or more computer-readable storage medium of claim 12,
the acts further comprising, prior to spawning the one or more child functions:
allocating to the executing thread storage space in the memory for two or more stacks; and
allocating to the executing thread storage space in the memory for the double-ended queue;
wherein the two or more stacks comprise the current call/return stack of the executing thread and one or more other call/return stacks; and
wherein acquiring the empty stack as a new call/return stack comprises adopting one of the one or more other call/return stacks allocated to the executing thread.

18. The one or more computer-readable storage medium of claim 12,
the acts further comprising executing one or more library functions;
wherein spawning the child function comprises invoking execution of at least one of the one or more library functions to implement pushing the respective stack frame element onto the double-ended queue; and
wherein executing the sync function comprises invoking execution of one of the one or more library functions that is executable to implement the sync function.

19. A method, comprising:
performing, by a computing device comprising one or more processors:
pre-allocating a fixed number of stacks for each executing thread;
a parent function of an executing thread spawning one or more child functions suitable for execution in parallel with the parent function on one or more processors, wherein spawning a child function comprises pushing a respective stack frame element that represents the spawned child function onto a double-ended queue that is associated with the executing thread and that is further configured to record spawned child functions of the executing thread;
subsequent to spawning the one or more child functions, the parent function executing a sync function associated with the one or more spawned child functions; and
subsequent to executing the sync function,
abandoning a current call/return stack as an orphan stack;
acquiring an empty stack as a new call/return stack; and
attempting to steal work from another thread.

20. The method of claim 19,
wherein executing the sync function comprises determining whether any of the respective stack frame elements that represent the one or more spawned child functions remain in the double-ended queue; and
wherein the abandoning and the attempting to steal work are performed in response to determining that none of the one or more spawned child functions remain in the double-ended queue and that not all of the one or more spawned child functions have returned.

21. The method of claim 19,
wherein executing the sync function comprises determining whether any of the respective stack frame elements that represent the one or more spawned child functions remain in the double-ended queue;
wherein the method further comprises, prior to the abandoning:
removing one or more respective stack frame elements that represent the one or more spawned child functions; and
executing the respective spawned child functions that are represented by the one or more removed stack frame elements;
wherein the removing and the executing are performed in response to determining that at least one of the one or more spawned child functions remains in the double-ended queue.

22. The method of claim 19, wherein attempting to steal work from another thread comprises:
identifying a stack frame element in a double-ended queue associated with the other thread that represents a spawned child function available for execution;
removing the identified stack frame element from the double-ended queue associated with the other thread; and
executing the spawned child function that is represented by the identified stack frame element.

23. The method of claim 22, wherein attempting to steal work from another thread further comprises:
the executing thread determining whether the spawned child function that is represented by the identified stack frame element is a last spawned child function of a spawning function on an orphan stack of the other thread to be executed; and
in response to determining that the spawned child function that is represented by the identified stack frame element is the last spawned child function of a spawning function on an orphan stack of the other thread to be executed:
the executing thread releasing the new call/return stack;
the executing thread adopting the orphan stack of the other thread as an adopted call/return stack; and
the executing thread continuing execution of the other thread at a point beyond a sync function associated with the last spawned child function.

24. The method of claim 19, further comprising, prior to spawning the one or more child functions:
allocating to the executing thread storage space in the memory for two or more stacks; and
allocating to the executing thread storage space in the memory for the double-ended queue;
wherein the two or more stacks comprise the current call/return stack of the executing thread and one or more other call/return stacks; and
wherein acquiring the empty stack as a new call/return stack comprises adopting one of the one or more other call/return stacks allocated to the executing thread.

25. The method of claim 19,
wherein spawning the child function comprises invoking execution of a library function to implement pushing the respective stack frame element onto the double-ended queue; and
wherein executing the sync function comprises invoking execution of a library function that is executable to implement the sync function.
